(19) United States
(12) Patent Application Publication
(10) Pub. No.: US 2024/0086840 A1
(43) Pub. Date: Mar. 14, 2024

(54) METHOD FOR ALLOCATING ORDER, DEVICE, ELECTRONIC EQUIPMENT, AND STORAGE MEDIUM

(71) Applicant: SHENZHEN KUBO SOFTWARE CO., LTD, Shenzhen (CN)

(72) Inventor: Hongxia ZHOU, Shenzhen (CN)

(21) Appl. No.: 18/511,183

(22) Filed: Nov. 16, 2023

Related U.S. Application Data
(63) Continuation of application No. PCT/CN2022/086413, filed on Apr. 12, 2022.

(30) Foreign Application Priority Data
May 21, 2021 (CN) 202110559226.5

(51) Int. Cl. G06Q 10/087

(52) U.S. Cl. CPC G06Q 10/087

(57) ABSTRACT

The present disclosure provides a method for allocating an order, device, electronic equipment, and storage medium. The method for allocating an order includes: determining order information of an order to be allocated; determining a current order-receiving strategy of each workstation; and allocating the order to be allocated to a target workstation according to the current order-receiving strategy of each workstation and the order information, where the order to be allocated meets the current order-receiving strategy of the target workstation.

### CROSS-REFERENCE TO RELATED APPLICATIONS

This application is a continuation of International Patent Application No. PCT/CN 2022/086413 filed on Apr. 12, 2022, which claims priority to Chinese patent application No. 202110559226.5, entitled “METHOD FOR ALLOCATING ORDER, DEVICE, ELECTRONIC EQUIPMENT, AND STORAGE MEDIUM”, filed with the China National Intellectual Property Administration on May 21, 2021, both of which are incorporated herein by reference in their entireties.

### TECHNICAL FIELD

The present disclosure relates to the intelligent control technologies, and in particular, to a method for allocating an order, device, electronic equipment, and storage medium.

### BACKGROUND

Accompanied with the development of the computer technologies, especially the rise of online shopping, the requirements on logistics and distribution in modern society are constantly increasing. To improve the efficiency, the combination of warehousing and logistics is becoming closer. In an intelligent warehousing system, goods storage and package for shipment can be implemented simultaneously. Generally, the system may distribute an order to a picking workstation, control the transport equipment to transport the goods involved in the order from the storage position to the workstation for picking, and finally complete order retrieval.

In a warehousing system, there are a large number of different orders to be processed every day, and the quantity of workstations is limited. Therefore, the rationality of order distribution for the workstations directly affects the shipment efficiency of the warehousing system. However, a few of influence factors are taken into account in the commonly used order distribution method, resulting in irrational order dispatching and low shipment efficiency.

### SUMMARY

The present disclosure provides an method for allocating an order, device, electronic equipment, and storage medium, in which various influence factors are taken into account, thereby enhancing the rationality of order dispatching and improving the shipment efficiency.

According to a first aspect, the present disclosure provides an method for allocating an order, including:
determining order information of an order to be allocated;
determining a current order-receiving strategy of each workstation; and
allocating the order to be allocated to a target workstation according to the current order-receiving strategy of each workstation and the order information, wherein the order to be allocated meets the current order-receiving strategy of the target workstation.

Optionally, the method for allocating an order further includes:
for each workstation, when a workstation is not allocated with an order that meets the current order-receiving strategy of the workstation within a preset duration, adjusting the order-receiving strategy of the workstation.

Optionally, the method for allocating an order further includes:
presetting a plurality of order-receiving strategies and priorities of the plurality of order-receiving strategies for each workstation according to an attribute of each workstation respectively; and
wherein the when a workstation is not allocated with an order that meets the current order-receiving strategy within a preset duration, adjusting the order-receiving strategy of the workstation comprises:
when the workstation is not allocated with the order that meets the current order-receiving strategy within the preset duration, adjusting the order-receiving strategy of the workstation, wherein a priority of an adjusted order-receiving strategy is lower than that of the current order-receiving strategy.

Optionally, the method for allocating an order further includes:
when a quantity of orders that meet the current order-receiving strategy allocated within the preset duration is greater than or equal to a preset value, adjusting the order-receiving strategy of the workstation, wherein a priority of an adjusted order-receiving strategy is higher than that of the current order-receiving strategy.

Optionally, the allocating the order to be allocated to a target workstation according to the current order-receiving strategy of each workstation and the order information includes:
grouping a plurality of orders to be allocated into at least one batch according to the order information; and
for each batch, allocating orders to be allocated to a corresponding workstation according to the current order-receiving strategy of each workstation; and
the method further includes:
adjusting the order-receiving strategy of the workstation to an order-receiving strategy having a highest priority after an operation of allocating orders to a corresponding workstation is completed.

Optionally, the attribute of each workstation includes a general attribute and a special attribute, the special attribute is an attribute different from that of another workstation; and
the presetting a plurality of order-receiving strategies and priorities of the plurality of order-receiving strategies for each workstation according to an attribute of each workstation includes:
setting at least one first order-receiving strategy and a corresponding priority according to the special attribute of a workstation; and
setting at least one second order-receiving strategy and a corresponding priority according to the general attribute of the workstation;
wherein the priority of the first order-receiving strategy is higher than that of the second order-receiving strategy.

Optionally, the special attribute of the workstation includes: a storage position for a large item;
the first order-receiving strategy comprises: receiving an order in which a volume of an item involved is greater than a preset value; and
the allocating the order to be allocated to a target workstation according to the current order-receiving strategy of each workstation and the order information includes:
selecting an order in which a volume of an item involved is greater than the preset value from orders according to the first order-receiving strategy, and allocating the order to the workstation.

Optionally, the presetting a plurality of order-receiving strategies and priorities of the plurality of order-receiving strategies for each workstation according to an attribute of each workstation respectively includes:
determining a size of an item in an order that the workstation is capable of processing according to a quantity of compartments of a put wall of the workstation, a size of each compartment and a picking method of the workstation; setting corresponding order-receiving strategies related to item size and corresponding priorities according to the size of the item in the order that the workstation is capable of processing;
and/or,
determining a processing-efficiency ranking of a plurality of types of orders according to types of orders processed in the past in the workstation and corresponding processing speeds of the workstation; and setting corresponding order-receiving strategies related to order type and corresponding priorities according to the processing-efficiency ranking of the plurality of types of orders.

Optionally, the determining order information of an order to be allocated includes:
determining task information; and
when the task information indicates that the task is an order task, determining the order information; and
the method further includes:
when the task information indicates that the task is an inventory-counting task, determining inventory-counting task information and allocating the inventory-counting task to the workstation.

Optionally, the inventory-counting task information includes a type of the inventory-counting task; and
the allocating the inventory-counting task to the workstation includes:
allocating the inventory-counting task to the workstation according to the type of the inventory-counting task, the current order-receiving strategy of each workstation, and a current quantity of orders at each workstation.

Optionally, the allocating the inventory-counting task to the workstation according to the type of the inventory-counting task, the current order-receiving strategy of each workstation, and a current quantity of orders at each workstation includes:
for each workstation, when the priority of the current order-receiving strategy of the workstation is lower than a preset priority and the quantity of orders is less than a preset value, allocating the inventory-counting task to the workstation according to the type of the inventory-counting task and the attribute of the workstation.

Optionally, the inventory-counting task type includes visual inventory counting and RFID inventory counting; and
the allocating the inventory-counting task to the workstation according to the type of the inventory-counting task includes:
when the type of the inventory-counting task is the visual inventory counting and the workstation is equipped with an image identification device, allocating the inventory-counting task to the workstation; and
when the type of the inventory-counting task is the RFID inventory counting and the workstation is equipped with an RFID identification device, allocating the inventory-counting task to the workstation.

According to a second aspect, the present disclosure provides a device for allocating an order, including:
an order-information determining module, configured to determine order information of an order to be allocated;
an order-receiving strategy determining module, configured to determine a current order-receiving strategy of each workstation; and
an order allocation module, configured to allocate the order to be allocated to a target workstation according to the current order-receiving strategy of each workstation and the order information, wherein the order to be allocated meets the current order-receiving strategy of the target workstation.

Optionally, the order dispatch device further includes:
an order-receiving strategy adjustment module, configured to: for each workstation, when a workstation is not allocated with an order that meets the current order-receiving strategy of the workstation within a preset duration, adjust the order-receiving strategy of the workstation.

Optionally, the order dispatch device further includes:
an order-receiving strategy setting module, configured to: preset a plurality of order-receiving strategies and priorities of the plurality of order-receiving strategies for each workstation according to an attribute of each workstation respectively; and
the order-receiving strategy adjustment module is specifically configured to:
when the workstation is not allocated with the order that meets the current order-receiving strategy within the preset duration, adjust the order-receiving strategy of the workstation, wherein a priority of an adjusted order-receiving strategy is lower than that of the current order-receiving strategy.

Optionally, the order-receiving strategy adjustment module is further configured to:
when a quantity of orders that meet the current order-receiving strategy allocated within the preset duration is greater than or equal to a preset value, adjust the order-receiving strategy of the workstation, wherein a priority of an adjusted order-receiving strategy is higher than that of the current order-receiving strategy.

Optionally, the order distribution module specifically configured to:
Group a plurality of orders to be allocated into at least one batch according to the order information; and
for each batch, allocate orders to be allocated to a corresponding workstation according to the current order-receiving strategy of each workstation; and
The order-receiving strategy adjustment module is further configured to:
adjust the order-receiving strategy of the workstation to an order-receiving strategy having a highest priority after an operation of allocating orders to a corresponding workstation is completed.

Optionally, the attributes of the workstation include: a general attribute and special attribute, where the special attribute is an attribute different from that of another workstation; and

The order-receiving strategy setting module is specifically configured to:
set at least one first order-receiving strategy and a corresponding priority according to the special attribute of a workstation; and
set at least one second order-receiving strategy and a corresponding priority according to the general attribute of the workstation;
the priority of the first order-receiving strategy is higher than that of the second order-receiving strategy.

Optionally, the special attribute of the workstation includes: a storage position for a large item;
the first order-receiving strategy includes: receiving an order in which a volume of an item involved is greater than a preset value; and
the order distribution module is specifically configured to:
select an order in which a volume of an item involved is greater than the preset value from orders according to the first order-receiving strategy, and allocating the order to the workstation.

Optionally, the order-receiving strategy setting module is specifically configured to:
determine a size of an item in an order that the workstation is capable of processing according to a quantity of compartments of a put wall of the workstation, a size of each compartment and a picking method of the workstation; and set corresponding order-receiving strategies related to item size and corresponding priorities according to the size of the item in the order that the workstation is capable of processing;
and/or,
determine a processing-efficiency ranking of a plurality of types of orders according to types of orders processed in the past in the workstation and corresponding processing speeds of the workstation; and set corresponding order-receiving strategies related to order type and corresponding priorities according to the processing-efficiency ranking of the plurality of types of orders.

Optionally, the order information determining module is specifically configured to:
determine task information; and
when the task information indicates that the task is an order task, determining the order information; and
the device for allocating an order further includes:
a task distribution module, configured to: when the task information indicates that the task is an inventory-counting task, determining inventory-counting task information and allocating the inventory-counting task to the workstation.

Optionally, the inventory-counting task information includes an inventory-counting task type; and
the task distribution module is specifically configured to:
allocate the inventory-counting task to the workstation according to the type of the inventory-counting task, the current order-receiving strategy of each workstation, and a current quantity of orders at each workstation.

Optionally, the task distribution module is specifically configured to:
for each workstation, when the priority of the current order-receiving strategy of the workstation is lower than a preset priority and the quantity of orders is less than a preset value, allocate the inventory-counting task to the workstation according to the type of the inventory-counting task and the attribute of the workstation.

Optionally, the inventory-counting task type includes visual inventory counting and RFID inventory counting; and
when allocating the inventory-counting task to the workstation according to the inventory-counting task type, the task allocation module is specifically configured to:
when the type of the inventory-counting task is the visual inventory counting and the workstation is equipped with an image identification device, allocating the inventory-counting task to the workstation; and
when the type of the inventory-counting task is the RFID inventory counting and the workstation is equipped with an RFID identification device, allocating the inventory-counting task to the workstation.

According to a third aspect, the present disclosure provides electronic equipment, including: a memory, configured to store program instructions; and a processor, configured to invoke and execute the program instructions in the memory, to perform the method according to the first aspect.

According to a fourth aspect, the present disclosure provides a computer-readable storage medium, storing a computer program, where the computer program, when executed by a processor, implements the method according to the first aspect.

According to a fifth aspect, the present disclosure provides a computer program product, including a computer program, where the computer program, when executed by a processor, implements the method according to the first aspect.

The present disclosure provides a method for allocating an order, device, electronic equipment, and storage medium. The method for allocating an order includes: determining order information of an order to be allocated; determining a current order-receiving strategy of each workstation; and allocating the order to be allocated to a target workstation according to the current order-receiving strategy of each workstation and the order information, where the order to be allocated meets the current order-receiving strategy of the target workstation. In the method of the present disclosure, by setting order-receiving strategies for workstations and allocating an order to be allocated to a target workstation that meets an order-receiving strategy in combination with order information of the order to be allocated and the order-receiving strategies of the workstations, the orders processed by the workstations are enabled to match the order-receiving strategies of the workstations, so as to ensure the processing efficiencies of the workstations, enhance the rationality of order dispatching, and improve the shipment efficiency.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic diagram of an application scenario provided by the present disclosure;

FIG. 2 is a flowchart of an method for allocating an order provided by an embodiment of the present disclosure;

FIG. 3 is a schematic structural diagram of a device for allocating an order provided by an embodiment of the present disclosure; and

FIG. 4 is a schematic structural diagram of electronic equipment provided by an embodiment of the present disclosure.

### DETAILED DESCRIPTION

In order to make the objectives, technical solutions, and advantages of the embodiments of the present disclosure clearer, the technical solutions in the embodiments of the present disclosure will be clearly and completely described with reference to the accompanying drawings in the embodiments of the present disclosure. Apparently, the described embodiments are a part of the embodiments of the present disclosure, but not all the embodiments. All other embodiments obtained by a person of ordinary skill in the art based on the embodiments of the present disclosure without creative efforts shall fall within the protection scope of the present disclosure.

A commonly used order allocation solution mainly includes grouping batches based on attributes such as order types, shippers, order durations, and merchants, then matching the batches with workstations, and then allocating the workstations according to degrees of matching. In such the method for allocating an order, only the related attributes of the orders are taken into account, but special attributes of each workstation that may also affect the order processing efficiency are ignored, resulting in unsatisfactory order distribution results.

Therefore, the present disclosure provides a method for allocating an order, device, electronic equipment, and storage medium, in which various influence factors are taken into account, thereby enhancing the rationality of order dispatching and improving the shipment efficiency.

FIG. 1 is a schematic diagram of an application scenario provided by the present disclosure. As shown in FIG. 1, the application scenario includes terminal equipment 10, a plurality of workstations 20, a plurality of robots 30, and a warehouse 40 storing a plurality of inventory items.

The terminal equipment 10 may be any type of electronic computing platform or equipment as a control core of the entire order dispatch system. According to actual needs, the terminal equipment 10 may have corresponding storage space or computing capabilities to provide one or more application services or functions, for example, receiving orders, allocating orders, issuing orders, or controlling the robots to perform tasks of retrieving and placing container, and the like.

The workstation 20 is integrated equipment that can be used for shipment operations. According to an actual shipment process or design requirements, one or more different types of action mechanisms and functional modules are provided, for example, a put wall for temporary storage of goods, manipulators for picking goods, and the like. The quantity of the workstations may be determined by one or more indicators such as the area of the warehouse, the construction cost, the goods flow, and the shipment efficiency. For example, three or more workstations may be arranged.

The robot 30 is automation equipment that is provided with a walking mechanism and that can move between the workstation 20 and the warehouse 40 and transport a container to perform operations of retrieving and placing container. The walking mechanism may adopt any suitable type of power system. The robot 30 may load at least one container at a time.

The warehouse 40 is a region for storing the containers. To facilitate management, the warehouse 40 may be provided with a plurality of racks, each rack may be provided with a plurality of layers, on which a plurality of container are placed. At least one type of inventory item is stored in each container. The container refers to a container that carries the inventory item, and may be a pallet, a box, or the like.

In the scenario, the method for allocating an order provided by this embodiment of the present disclosure may be applied to rationally allocate orders to be allocated to the workstations and control the robots to transport the corresponding inventory items to the workstations from the warehouse region according to the orders, so as to complete the order fulfillment.

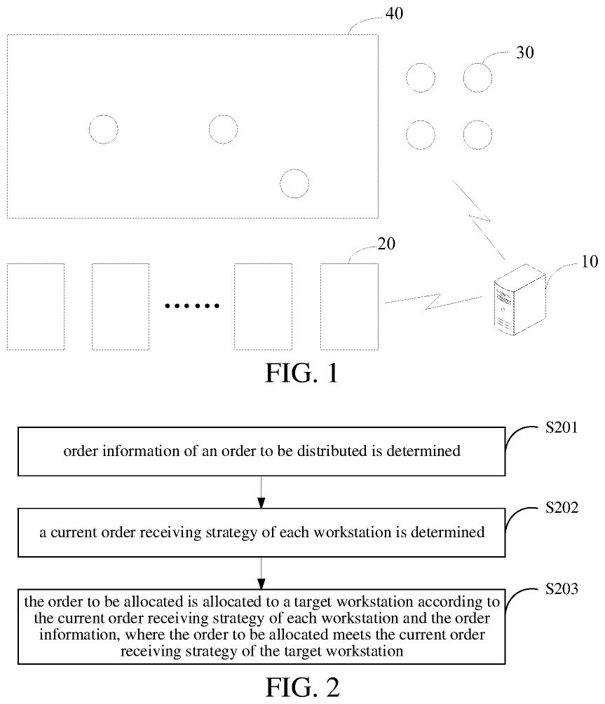

FIG. 2 is a flowchart of an method for allocating an order provided by an embodiment of the present disclosure. As shown in FIG. 2, the method of this embodiment may include the following operations:

S201: order information of an order to be allocated is determined.

An order that has been generated and has not yet been allocated is referred to as an order to be allocated. The order to be allocated may be imported from another order generation system.

The order information of the order to be allocated includes the order deadline, the attribute information of the inventory item (a type, brand, size, weight, or the like of a commodity), and the like.

S202: a current order-receiving strategy of each workstation is determined.

According to the description of the corresponding scenario in FIG. 1, the structures and functions of the plurality of workstations in a warehouse may be configured according to actual requirements, that is, the hardware configurations of the workstations may be different. The current order processing situations and the processing efficiencies of different orders may not be the same for the different workstations.

Therefore, different order-receiving strategies may be set for the different workstations, and different order-receiving strategies may be set for different situations for the same workstation.

During order allocation, the current order-receiving strategy of each workstation may be determined, to facilitate targeted order allocation.

The order-receiving strategy of a workstation refers to the order receiving rule of the workstation, for example, a particular type of orders may be preferably allocated to the workstation.

In some embodiments, an order-receiving strategy system may be provided for automatically generating at least one order-receiving strategy according to information of various parameters of the workstation and/or dynamically adjusting the order-receiving strategy of the workstation. When executing the method of this embodiment, the current order-receiving strategies of the workstations may be determined by accessing the order-receiving strategy system.

S203: the order to be allocated is allocated to a target workstation according to the current order-receiving strategy of each workstation and the order information, where the order to be allocated meets the current order-receiving strategy of the target workstation.

After the order information and the order-receiving strategies of the workstations are determined, the order may be allocated to a target workstation according to degrees of matching between the order and the order-receiving strategy of the target workstation. The target workstation refers to a workstation to which an order is finally determined to allocated.

It may be understood that there may be a plurality of orders to be allocated and target workstations to which some of the orders correspond are the same workstation.

To ensure the order processing efficiencies of the workstations, upper limits of order receiving may be set for the workstations while order allocation is performed according to the degrees of matching. For example, the quantity of orders allocated to a workstation that have not yet been shipped is required to be less than or equal to a preset value. The excessive orders are sequentially allocated to workstations having slightly lower degrees of matching.

Optionally, the target workstation includes at least one put wall, the put wall is divided into a plurality of compartments. Each compartment is configured to store the inventory items corresponding to one order or one combined order. The working personnel or robotic arm of the target workstation may pick the items corresponding to the orders allocated to the target workstation to the corresponding compartment. Specifically, the order-receiving strategies of the plurality of compartments in the target workstation may also be different. The order-receiving strategy of each compartment may be one or more of the order-receiving strategies of the target workstation. For example, the current order-receiving strategy of the target workstation is that orders from a supplier 1, a supplier 2, and a supplier 3 can be received. Among 10 compartments of the target workstation, a compartment A exists, the order-receiving strategy of which is that orders from the supplier 1 and the supplier 2 can be received, a compartment B exists, the order-receiving strategy of which is that orders from the supplier 2 and the supplier 3 can be received, and so on. Still for example, the order-receiving strategy of the target workstation is that not only orders involving one inventory item can be received, but also orders involving a plurality of inventory items can be received, where a compartment C of the target workstation is for receiving only orders involving one inventory item and a compartment D of the target workstation is for receiving only orders involving a plurality of inventory items, and so on. When the order to be allocated is allocated to the target workstation according to the foregoing method, the order-receiving strategies of compartments that are of the workstation and that are currently in an idle state also need to be taken into account while the order-receiving strategies of the workstation are taken into account. When a compartment that meets the properties of the order to be allocated and that is in the idle state exists, the order to be processed is allocated to the target workstation corresponding to the compartment that meets the properties of the order to be allocated and that is in the idle state.

The method for allocating an order provided by this embodiment includes: determining order information of an order to be allocated; determining a current order-receiving strategy of each workstation; and allocating the order to be allocated to a target workstation according to the current order-receiving strategy of each workstation and the order information, where the order to be allocated meets the current order-receiving strategy of the target workstation. In the method of the present disclosure, by setting order-receiving strategies for workstations according to attribute information of the workstations and allocating an order to be allocated to a target workstation that meets the order-receiving strategy in combination with order information of the order to be allocated and the order-receiving strategies of the workstations, the orders processed by the workstations are enabled to match the order-receiving strategy of the workstation, so as to ensure the processing efficiencies of the workstations, enhance the rationality of order allocating, and improve the shipment efficiency.

In some embodiments, for each workstation, when the workstation is not allocated with an order that meets the current order-receiving strategy within a preset duration, the order-receiving strategy of the workstation is adjusted.

Generally, in a case that the quantity of orders to be allocated is large and the types of the orders are diversified, the orders may be allocated to the workstations. when a particular workstation is not allocated with an order within a preset duration for order allocation, the reason may be that the current order to be allocated does not match the current order-receiving strategy of the workstation. The situation in which there is a workstation that is not allocated with an order may indirectly lead to an excessively large quantity of orders for the other workstations and a great processing pressure. In this case, the order-receiving strategy of the workstation that is not allocated with an order may be adjusted, so as to improve the degree of matching with the current batch of orders to be allocated, so that the workstation can be allocated with an order that meets the new order-receiving strategy in a subsequent distribution process, thereby sharing the processing pressure of the other workstations and improving the overall processing efficiency.

To prevent over-adjustment, whether an order-receiving strategy needs to be adjusted is determined in combination with a current allocation situation of orders to be allocated. For example, whether the strategy of a workstation to which no order is allocated needs to be adjusted is determined according to a current quantity of orders to be allocated and an allocation situation of the workstations. For example, when the variance of the quantities of current orders to be allocated at the workstations is less than a preset value, which indicates that the types of the current orders to be allocated are relatively uniform, in this case, the order-receiving strategy of the workstation to which no order is allocated may be adjusted.

In some embodiments, for each workstation, a plurality of order-receiving strategies and priorities of the order-receiving strategies are preset according to an attribute of the workstation. Correspondingly, the operation of adjusting the order-receiving strategy of the workstation when the workstation is not allocated with an order that meets the current order-receiving strategy within a preset duration includes: when the workstation is not allocated with the order that meets the current order-receiving strategy within the preset duration, adjusting the order-receiving strategy of the workstation, where a priority of an adjusted order-receiving strategy is lower than that of the current order-receiving strategy.

For each workstation, a plurality of order-receiving strategies may be preset, and the plurality of order-receiving strategies may be ranked according to priorities. Specifically, an order-receiving strategy that has a nearer special attribute feature of the workstation may be set to a higher priority, and an order-receiving strategy that corresponds to a more general feature may be set to a low priority. When adjusting the order-receiving strategy, different order-receiving strategies may be switched according to a ranking of the priorities. Specifically, in a case that no order is distributed within a preset duration, the order-receiving strategy having a high priority may be adjusted to an order-receiving strategy having a lower priority.

By setting the priorities of the order-receiving strategies and adjusting the order-receiving strategies according to the priorities, it is more conducive to a workstation to prioritize the processing of orders having a higher degree of relevance to the attributes of the workstation, to achieve the targeted order distribution, so that the overall order distribution and processing efficiency is high.

In some other embodiments, when a quantity of orders that meet the current order-receiving strategy allocated within the preset duration is greater than or equal to a preset value, the order-receiving strategy of the workstation is adjusted, where a priority of an adjusted order-receiving strategy is higher than that of the current order-receiving strategy.

Corresponding to the previous embodiment, when the quantity of orders allocated within the preset duration is excessively large, it may be considered that the attribute feature corresponding to the current order-receiving strategy is excessively general. In this case, the order-receiving strategy may be adjusted to an order-receiving strategy having a higher priority, so as to achieve a better screening effect on the orders, thereby reducing the quantity of orders allocated and avoiding excessive picking pressure of the workstation.

In some embodiments, the operation of allocating the order to be allocated to a target workstation according to the current order-receiving strategy of each workstation and the order information may include: grouping a plurality of orders to be allocated into at least one batch according to the order information; and for each batch, allocating orders to be allocated to the target workstation according to the current order-receiving strategy of the workstation. Correspondingly, the method for allocating an order may further include operation of adjusting the order-receiving strategy of the workstation to an order-receiving strategy having a highest priority after an operation of allocating orders in each batch is completed.

Before allocating the orders to be allocated, the orders may be first grouped into batches, and then orders of each batch are allocated separately. The order-receiving strategies for some workstations may be adjusted during the order allocation process for each batch, and therefore it is also possible to adjust the order-receiving strategy of each workstation back to the order-receiving strategy having the highest priority after the order allocation for each batch is completed. By intermittently adjusting the order-receiving strategy back to the strategy having the highest priority, the orders allocated to the workstation can match the attributes of the workstation as far as possible, thereby improving the overall processing efficiency.

The basis of batch grouping may be the order deadline of each order. Priority is given to allocation of a batch having an earlier order deadline, and in this case, the fulfillment time of the order is not affected either. Certainly, the batch grouping may also be performed according to other factors.

In some embodiments, the attribute of the workstation may include: a general attribute and special attribute. The special attribute is an attribute different from that of another workstation. Correspondingly, the operation of presetting a plurality of order-receiving strategies and priorities of the order-receiving strategies according to an attribute of the workstation includes: setting at least one first order-receiving strategy and a corresponding priority according to the special attribute of the workstation; and setting at least one second order-receiving strategy and a corresponding priority according to the general attribute of the workstation. The priority of the first order-receiving strategy is higher than that of the second order-receiving strategy.

The attribute of the workstation may include two categories, that is general attributes and special attributes. The general attributes refer to attributes possessed by all the workstations and having different parameters, for example, the quantity of grids of a put wall, the grid size, and the like. The special attributes refer to attributes not possessed by every workstation, for example, storage positions for large goods, a dedicated package for a particular type of goods, and the like. The strategy corresponding to the special attribute is referred to as a first order-receiving strategy and the strategy corresponding to the general attribute is referred to as a second order-receiving strategy. Because a workstation that has a special attribute also has a general attribute and a workstation has a general attribute does not necessarily have a special attribute, there are fewer distributable workstations corresponding to an order having a special attribute, and in the distribution process, the order should be distributed to a workstation having the special attribute as far as possible. Therefore, the priority of the first order-receiving strategy is higher than that of the second order-receiving strategy. The ranking of the priorities of a plurality of first order-receiving strategies and the ranking of the priorities of a plurality of second order-receiving strategies may further be set according to an actual situation.

In some specific embodiments, if the special attribute of the workstation includes: a storage position for a large item, the corresponding first order-receiving strategy may include: receiving an order in which a volume of an item involved is greater than a preset value. Correspondingly, the operation of allocating the order to be allocated to a target workstation according to the current order-receiving strategy of each workstation and the order information includes: selecting an order in which the volume of an item involved is greater than the preset value from the orders according to the first order-receiving strategy, and allocating the order to the workstation.

In some embodiments, the for each workstation, the operation of presetting a plurality of order-receiving strategies and priorities of the order-receiving strategies according to attributes of the workstation includes: determining a size of an item in an order that the workstation is capable of processing according to a quantity of compartments of a put wall of the workstation, a size of each compartment and a picking method of the workstation; setting corresponding order-receiving strategies related to item size and corresponding priorities according to the size of the item in the order that the workstation is capable of processing; and/or, determining a processing-efficiency ranking of a plurality of types of orders according to types of orders processed in the past in the workstation and corresponding processing speeds of the workstation; and setting corresponding order-receiving strategies related to order type and corresponding priorities according to the processing-efficiency ranking of the plurality of types of orders.

The order-receiving strategy may be further divided into an order-receiving-strategy related to item size and an order-receiving strategy related to type, or the like. The order-receiving strategy related to item size means that a workstation may prioritize an order corresponding an item of a particular size, and the particular size may be determined based on attributes such as the size of an compartment of the put wall and the picking method of the workstation. A relatively large compartment of the put wall allows a relatively large size of a largest item to be stored. However, if the picking method of the workstation is manual picking, the size of the item that can be handled efficiently may be slightly smaller than that of mechanical picking, which can ensure the efficiency of the manual picking. The order receiving strategy related to type means that a workstation may prioritize an order corresponding to a particular type of item, and the particular type may be determined based on the types of orders processed in the past in the workstation and the corresponding processing speeds. For example, if the processing efficiency of a particular type of orders in the orders processed in the past is higher than that of the other types of orders, it can be determined that the orders of the type have the highest priority.

In some embodiments, the operation of determining order information of an order to be allocated may include: determining task information; and if the task information indicates that the task is an order task, determining the order information. Correspondingly, the method further includes: if the task information indicates that the task is an inventory-counting task, determining inventory-counting task information and allocating the inventory-counting task to the workstation.

A task allocation system may be provided to allocate tasks for the entire warehouse. The tasks may include order tasks (item outbound) and inventory-counting tasks (item inventory). The task allocation system sends a task to the order allocation system, which determines a task type according to key information in the task and executes the corresponding steps in the method for allocating an order to allocate the order. If the task information indicates that the task is an order task, the steps in the foregoing embodiments are performed to allocate the order to be allocated to the workstation; and if the task information indicates that the task is an inventory-counting task, the inventory-counting task is allocated to the workstation.

In some embodiments, the inventory-counting task information includes a type of the inventory-counting task. Correspondingly, the operation of allocating the inventory-counting task to the workstation includes: allocating the inventory-counting task to the workstation according to the type of the inventory-counting task, the current order-receiving strategy of each workstation, and a current quantity of orders at each workstation.

The inventory-counting task information refers to the related information of the inventory-counting task, for example, which type of goods on which inventory counting is performed, the inventory counting time, the inventory counting duration, the inventory counting method, and the like. According to the information, the type of the inventory-counting task may be grouped, and the inventory-counting task may be allocated to a workstation according to degrees of matching between the type of the inventory-counting task and the current order-receiving strategies of the workstations, the current order situation of the workstations, and the like.

Specifically, the inventory-counting task may be preferentially distributed to a workstation having a higher degree of matching and fewer orders. For example, when allocating a particular inventory-counting task, the degrees of matching and the order situations are scored separately and weights are set for the degrees of matching and the order situations separately, to calculate comprehensive scores; and one or more workstations having the highest comprehensive score(s) to distribute the inventory-counting task. It may be understood that if the inventory-counting task is allocated to a plurality of workstations, the final inventory result of the inventory-counting task can be obtained by merging the inventory structures of the workstations after the inventory counting of the workstations is completed.

In some embodiments, the operation of allocating the inventory-counting task to the workstation according to the type of the inventory-counting task, the current order-receiving strategy of each workstation, and a current quantity of orders at each workstation includes: for each workstation, if the priority of the current order-receiving strategy of the workstation is lower than a preset priority and the quantity of orders is less than a preset count, allocating the inventory-counting task to the workstation according to the type of the inventory-counting task and the attributes of the workstation.

If the priority of the order-receiving strategy of a workstation is lower than a preset priority, it indicates that the order-receiving strategy of the workstation has been adjusted to be relatively low and there are fewer orders that meet the order-receiving strategy of the workstation, which indicates that the workstation is more substitutable in the order allocation process. In this case, an inventory-counting task that meets the attributes of the workstation may be allocated to the workstation.

In some embodiments, the type of the inventory-counting task includes visual inventory counting and RFID inventory counting. Correspondingly, the operation of allocating the inventory-counting task to the workstation according to the type of the inventory-counting task includes: if the inventory-counting task type is the visual inventory counting and the workstation is equipped with an image identification device, allocating the inventory-counting task to the workstation; and if the type of the inventory-counting task is the RFID inventory counting and the workstation is equipped with an RFID identification device, allocating the inventory-counting task to the workstation.

As described in the foregoing embodiments, the inventory-counting task information may include an inventory counting method, and the type of the inventory-counting task corresponding to the inventory method may include visual inventory counting, RFID inventory counting, and the like.

The visual inventory counting means performing task inventory counting based on machine vision, and image capturing or identification devices such as cameras and video cameras are used to perform identification and inventory counting on items to be inventory counted. Therefore, such the inventory-counting tasks may be allocated to a workstation equipped with an image identification device.

The RFID inventory counting means performing task inventory counting based on an RFID tag, and RFID identification equipment is used to identify an RFID tag of the item or the container where the item is located, to read related data for identification and inventory counting. Therefore, such the inventory-counting tasks may be allocated to a workstation equipped with RFID identification equipment.

In the solution of the present disclosure, for retrieval and/or inventory counting, orders may be allocated to a put wall of a workstation according to the filter conditions configured for the workstation. The types of orders that the workstations are capable of processing are different for different workstations. Specifically, a plurality of order-receiving strategies may be set for a workstation, and the type of a currently order that the workstation is capable of processing is determined according to a ranking of the strategies. The order-receiving strategies of the workstations may be set in different dimensions such as shippers, goods owners, paths, batches, quantities, stores, order types, batch types, batch structures, quantity of orders of each batch, platforms, shops, order deadlines, creation time, order priorities, and packaging types. By matching different workstations for orders according to the order type or the inventory counting type (ordinary inventory counting, dynamic inventory counting, visual inventory counting, RFID inventory counting), it is conductive to an operator to control the production rhythm more flexibly according to the actual business situation.

The following is a detailed description of the order distribution process by an example of a specific scenario. There are a plurality of workstations in a warehouse, in which only a first workstation has two vacant large item storage compartment, which can be used to store an item having a volume of not greater than 100 cm*100 cm*100 cm (generally, the maximum volume that can be accommodated at a compartment of a put wall is 50 cm*30 cm*20 cm). The picking method of the first workstation includes manual picking and mechanical picking. In addition, the first workstation has the highest processing efficiency for items of type A compared to the other workstations. Based on the basic attribute information of the first workstation, a plurality of order-receiving strategies may be formulated for the first workstation. The order-receiving strategy having the highest priority is “receiving an order that involves an item having a volume greater than 50 cm*30 cm*20 cm and smaller than 100 cm*100 cm*100 cm”, and the order-receiving strategy having the secondary highest priority is “receiving an order that involves items of type A”. In the order allocation process, if the first workstation does not receive an order by using the order-receiving strategy having the highest priority, it indicates that the current batch of orders does not include an order that involves an item having a volume greater than 50 cm*30 cm*20 cm and smaller than 100 cm*100 cm*100 cm. Therefore, the priority is adjusted to the secondary highest priority, and a total of four orders are received and processed. However, in this case, the quantity of unprocessed orders in the first workstation is 10 (20 in a saturation state). Therefore, the priority is continuously lowered to start to receive other orders, until the saturation state of shipment is reached. After allocation of this batch of orders is completed, the order-receiving strategy of the first workstation is adjusted back to the order-receiving strategy having the highest priority.

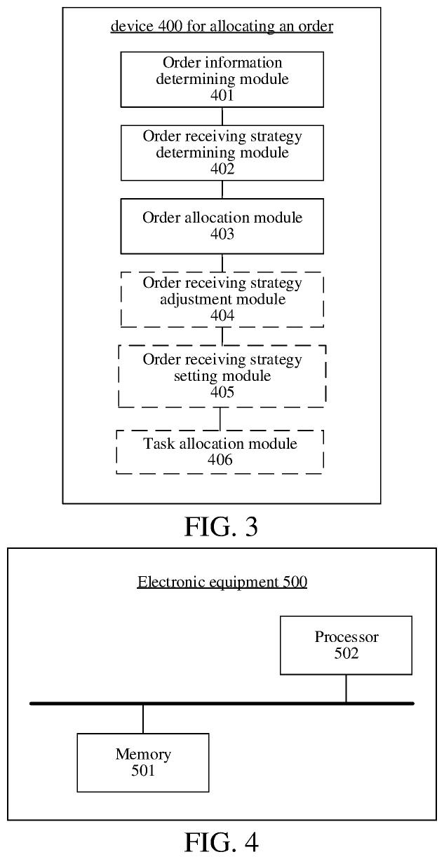

FIG. 3 is a schematic structural diagram of a device for allocating an order provided by an embodiment of the present disclosure. As shown in FIG. 3, a device for allocating an order 400 of this embodiment may include: an order information determining module 401, an order-receiving strategy determining module 402, and an order allocation module 403.

The order information determining module 401 is configured to determine order information of an order to be allocated.

The order-receiving strategy determining module 402 is configured to determine a current order-receiving strategy of each workstation.

The order allocation module 403 is configured to distribute the order to be allocated to a target workstation according to the current order-receiving strategy of each workstation and the order information, where the order to be allocated meets the current order-receiving strategy of the target workstation.

Optionally, the device for allocating an order 400 further includes:
an order-receiving strategy adjustment module 404, configured to: for each workstation, if the workstation is not allocated with an order that meets the current order-receiving strategy within a preset duration, adjust the order-receiving strategy of the workstation.

Optionally, the device for allocating an order 400 further includes:
an order-receiving strategy setting module 405, configured to: preset a plurality of order-receiving strategies and priorities of the order-receiving strategies for each workstation according to an attribute of each workstation respectively.

The order-receiving strategy adjustment module 404 is specifically configured to:
when the workstation is not allocated with the order that meets the current order-receiving strategy within the preset duration, adjust the order-receiving strategy of the workstation, where a priority of an adjusted order-receiving strategy is lower than that of the current order-receiving strategy.

Optionally, the order-receiving strategy adjustment module 404 is further configured to:
when a quantity of orders that meet the current order-receiving strategy allocated within the preset duration is greater than or equal to a preset value, adjust the order-receiving strategy of the workstation, where a priority of an adjusted order-receiving strategy is higher than that of the current order-receiving strategy.

Optionally, the order allocation module 403 is specifically configured to:
group a plurality of orders to be allocated into at least one batch according to the order information; and
for each batch, allocate the orders to be allocated to a corresponding workstation according to the current order-receiving strategy of each workstation.

The order-receiving strategy adjustment module 404 is further configured to:
adjust the order-receiving strategy of the workstation to an order-receiving strategy having a highest priority after an operation of allocating orders to a corresponding target workstation is completed.

Optionally, the attribute of each workstation include: a general attribute and a special attribute, where the special attribute is an attribute different from that of another workstation.

The order-receiving strategy setting module 405 is specifically configured to:
set at least one first order-receiving strategy and a corresponding priority according to the special attribute of a workstation; and
set at least one second order-receiving strategy and a corresponding priority according to the general attribute of a workstation, where
the priority of the first order-receiving strategy is higher than that of the second order-receiving strategy.

Optionally, the special attribute of a workstation includes: a storage position for a large item; and
the first order-receiving strategy includes: receiving an order in which a volume of an item involved is greater than a preset value.

The order allocation module 403 is specifically configured to:
select an order in which a volume of an item involved is greater than the preset value from the orders according to the first order-receiving strategy, and allocate the order to the workstation.

Optionally, the order-receiving strategy setting module 405 is specifically configured to:
determine a size of an item in an order that the workstation is capable of processing according to a quantity of compartments of a put wall and a size of each compartment and a picking method of the workstation; set corresponding order-receiving-strategies related to item size and corresponding priorities according to the size of the item in the order that the workstation is capable of processing;
and/or,
determine a processing-efficiency ranking of a plurality of types of orders according to types of orders processed in the past in the workstation and corresponding processing speeds of the workstation; and set corresponding order-receiving strategies related to type and corresponding priorities according to the processing-efficiency ranking of the plurality of types of orders.

Optionally, the order information determining module 401 is specifically configured to:
determine task information; and
when the task information indicates that the task is an order task, determine the order information; and
the order dispatch device further includes:
a task allocation module 406, configured to: when the task information indicates that the task is an inventory-counting task, determine inventory-counting task information and allocate the inventory-counting task to the workstation.

Optionally, the inventory-counting task information includes a type of the inventory-counting task.

The task allocation module 406 is specifically configured to:
allocate the inventory-counting task to the workstation according to the type of the inventory-counting task, the current order-receiving strategy of each workstation, and a current quantity of orders at each workstation.

Optionally, the task allocation module 406 is specifically configured to:
for each workstation, when the priority of the current order-receiving strategy of the workstation is lower than a preset priority and the quantity of orders is less than a preset count, distribute the inventory-counting task to the workstation according to the type of the inventory-counting task.

Optionally, the type of the inventory-counting task includes visual inventory counting and RFID inventory counting.

When allocating the inventory-counting task to the workstation according to the type of the inventory-counting task, the task allocation module 406 is specifically configured to:
when the type of the inventory-counting task is the visual inventory counting and the workstation is equipped with an image identification device, allocate the inventory-counting task to the workstation; and
when the type of the inventory-counting task is the RFID inventory counting and the workstation is equipped with an RFID identification device, allocate the inventory-counting task to the workstation.

The device provided in this embodiment may be configured to perform the method according to any of the foregoing embodiments. Their implementation principles and technical effects are similar. Details are not described herein again.

FIG. 4 is a schematic structural diagram of electronic equipment provided by an embodiment of the present disclosure. As shown in FIG. 4, electronic equipment 500 of this embodiment includes:
a memory 501, configured to store program instructions; and
a processor 502, configured to invoke and execute the program instructions in the memory 501, to perform the method according to any of the foregoing embodiments. Their implementation principles and technical effects are similar. Details are not described herein again.

The present disclosure also provides a computer-readable storage medium, storing a computer program, where the computer program, when executed by a processor, implements the method according to any of the foregoing embodiments.

The present disclosure also provides a computer program product, including a computer program, where the computer program, when executed by a processor, implements the method according to any of the foregoing embodiments.

A person of ordinary skill in the art may understand that: all or some of the steps of the method embodiments may be implemented by a program instructing relevant hardware. The program may be stored in a computer-readable storage medium. When the program is executed, steps of the foregoing method embodiments are performed. The foregoing storage medium includes: various media capable of storing program code, such as an ROM, an RAM, a magnetic disk, or a compact disc.

Finally, it should be noted that: the foregoing embodiments are merely used for describing the technical solutions of the present disclosure, but are not intended to limit the present disclosure. Although the present disclosure is described in detail with reference to the foregoing embodiments, it should be appreciated by a person skilled in the art that, modifications may still be made to the technical solutions described in the foregoing embodiments, or equivalent replacements may be made to part or all of the technical features; and these modifications or replacements will not cause the essence of corresponding technical solutions to depart from the scope of the technical solutions in the embodiments of the present disclosure.

What is claimed is:

1. A method for allocating an order, comprising:
determining order information of an order to be allocated;
determining a current order-receiving strategy of each workstation; and
determining, according to the current order-receiving strategy of each workstation and the order information, a workstation having a current order-receiving strategy meets the order to be allocated as a target workstation; and
allocating the order to be allocated to the target workstation.

2. The method according to claim 1, further comprising:
when a workstation is not allocated with an order that meets the current order-receiving strategy of the workstation within a preset duration, adjusting the current order-receiving strategy of the workstation.

3. The method according to claim 2, further comprising:
presetting a plurality of order-receiving strategies and priorities of the plurality of order-receiving strategies for each workstation according to an attribute of each workstation respectively; and
wherein in the when a workstation is not allocated with an order that meets the current order-receiving strategy within a preset duration, adjusting the current order-receiving strategy of the workstation, the current order-receiving strategy of the workstation is adjusted to an order-receiving strategy having a priority lower than that of the current order receiving strategy.

4. The method according to claim 3, further comprising:
when a workstation is allocated with a plurality of orders that meet the current order-receiving strategy of the workstation within the preset duration, and a quantity of the plurality of orders is greater than or equal to a first preset quantity value, adjusting the current order-receiving strategy of the workstation to an order-receiving strategy having a priority higher than that of the current order-receiving strategy.

5. The method according to claim 3, wherein the allocating the order to be allocated to the target workstation comprises:
grouping a plurality of orders to be allocated into at least one batch according to the order information; and
for each batch, allocating orders to be allocated to a corresponding target workstation according to the current order-receiving strategy of each workstation; and
the method further comprises:
adjusting the current order-receiving strategy of the workstation to an order-receiving strategy having a highest priority after an operation of allocating orders to a corresponding target workstation is completed.

6. The method according to claim 3, wherein the attribute of each workstation comprises a general attribute and a special attribute, the special attribute is an attribute different from that of another workstation; and
the presetting a plurality of order-receiving strategies and priorities of the plurality of order-receiving strategies for each workstation according to an attribute of each workstation comprises:
setting at least one first order-receiving strategy and a corresponding priority according to the special attribute of a workstation; and
setting at least one second order-receiving strategy and a corresponding priority according to the general attribute of the workstation;
wherein the priority of the first order-receiving strategy is higher than that of the second order-receiving strategy.

7. The method according to claim 6, wherein the special attribute of a workstation comprises: a storage position for a large item; and
the first order-receiving strategy comprises: receiving an order in which a volume of an item involved is greater than a preset volume value; and
the allocating the order to be allocated to a target workstation according to the current order-receiving strategy of each workstation and the order information comprises:
selecting an order in which a volume of an item involved is greater than the preset volume value from orders according to the first order-receiving strategy, and allocating the selected order to the workstation.

8. The method according to claim 3, wherein the presetting a plurality of order-receiving strategies and priorities of the plurality of order-receiving strategies for each workstation according to an attribute of each workstation respectively comprises:
determining a size of an item in an order that the workstation is capable of processing according to a quantity of compartments of a put wall of the workstation, a size of each compartment and a picking method of the workstation; setting corresponding order-receiving strategies related to item size and corresponding priorities according to the size of the item in the order that the workstation is capable of processing;
and/or,
determining a processing-efficiency ranking of a plurality of types of orders according to types of orders processed in the past in the workstation and corresponding processing speeds of the workstation; and setting corresponding order-receiving strategies related to order type and corresponding priorities according to the processing-efficiency ranking of the plurality of types of orders.

9. The method according to claim 1, wherein the determining order information of an order to be allocated comprises:
determining task information; and
when the task information indicates that the task is an order task, determining the order information; and
the method further comprises:
when the task information indicates that the task is an inventory-counting task, determining inventory-counting task information and allocating the inventory-counting task to the workstation.

10. The method according to claim 9, wherein the inventory-counting task information comprises a type of the inventory-counting task; and
the allocating the inventory-counting task to the workstation comprises:
allocating the inventory-counting task to the workstation according to the type of the inventory-counting task, the current order-receiving strategy of each workstation, and a current quantity of orders at each workstation.

11. The method according to claim 10, wherein the allocating the inventory-counting task to the workstation according to the type of the inventory-counting task, the current order-receiving strategy of each workstation, and a current quantity of orders at each workstation comprises:
for each workstation, when the priority of the current order-receiving strategy of the workstation is lower than a preset priority and the quantity of orders is less than a second preset quantity value, allocating the inventory-counting task to the workstation according to the type of the inventory-counting task and the attribute of the workstation.

12. The method according to claim 11, wherein the type of the inventory-counting task comprises visual inventory counting and RFID inventory counting; and
the allocating the inventory-counting task to the workstation according to the type of the inventory-counting task comprises:
when the type of the inventory-counting task is the visual inventory counting, allocating the inventory-counting task to a workstation equipped with an image identification device; and
when the type of the inventory-counting task is the RFID inventory counting, allocating the inventory-counting task to a workstation equipped with an RFID identification device.

14. Electronic equipment, comprising:
a memory, configured to store program instructions; and
a processor, configured to invoke and execute the program instructions in the memory, to perform operations of:
determining order information of an order to be allocated;
determining a current order-receiving strategy of each workstation; and
determining, according to the current order-receiving strategy of each workstation and the order information, a workstation having a current order-receiving strategy meets the order to be allocated as a target workstation; and
allocating the order to be allocated to the target workstation;
wherein each workstation is preseted with a plurality of order-receiving strategies, and the current order-receiving strategy is one of the plurality of order-receiving strategies;
the processor is configured to perform operation of switching, when a workstation is not allocated with an order that meets the current order-receiving strategy of the workstation within a preset duration, the current order-receiving strategy of the workstation to another order-receiving strategy of the workstation.

15. The electronic equipment according to claim 14, wherein each of the plurality of order-receiving strategies is preseted with a corresponding priority;
in the operation of switching, when a workstation is not allocated with an order that meets the current order-receiving strategy of the workstation within a preset duration, the current order-receiving strategy of the workstation to another order-receiving strategy of the workstation, the current order-receiving strategy of the workstation is switched to an order-receiving strategy having a priority lower than that of the current order receiving strategy.

16. The electronic equipment according to claim 15, wherein the processor is configured to perform operation of switching, when a workstation is allocated with a plurality of orders that meet the current order-receiving strategy of the workstation within the preset duration and a quantity of the plurality of orders is greater than or equal to a first preset quantity value, the current order-receiving strategy of the workstation to an order-receiving strategy having a priority higher than that of the current order-receiving strategy.

17. The electronic equipment according to claim 15, wherein the operation of allocating the order to be allocated to the target workstation comprises:
grouping a plurality of orders to be allocated into at least one batch according to the order information; and
for each batch, allocating orders to be allocated to a corresponding target workstation according to the current order-receiving strategy of each workstation; and
the processor is further configured to perform operation of:
switching the current order-receiving strategy of the workstation to an order-receiving strategy having a highest priority after an operation of allocating orders to a corresponding target workstation is completed.

18. The electronic equipment according to claim 14, wherein the operation of determining order information of an order to be allocated comprises: determining task information; and
when the task information indicates that the task is an order task, determining the order information;
the processor is further configured to perform operation of: when the task information indicates that the task is an inventory-counting task, determining inventory-counting task information and allocating the inventory-counting task to the workstation.

19. The electronic equipment according to claim 18, wherein the inventory-counting task information comprises a type of the inventory-counting task; and
the operation of allocating the inventory-counting task to the workstation comprises: allocating the inventory-counting task to the workstation according to the type of the inventory-counting task, the current order-receiving strategy of each workstation, and a current quantity of orders at each workstation;
the operation of allocating the inventory-counting task to the workstation according to the type of the inventory-counting task, the current order-receiving strategy of each workstation, and a current quantity of orders at each workstation comprises:
for each workstation, when the priority of the current order-receiving strategy of the workstation is lower than a preset priority and the quantity of orders is less than a second preset quantity value, allocating the inventory-counting task to the workstation according to the type of the inventory-counting task and the attribute of the workstation.

20. A non-transitory computer-readable storage medium, storing a computer program, wherein the computer program, when executed by a processor, is configured to implement operations of:
determining order information of an order to be allocated;
determining a current order-receiving strategy of each workstation; and
determining, according to the current order-receiving strategy of each workstation and the order information, a workstation having a current order-receiving strategy meets the order to be allocated as a target workstation; and
allocating the order to be allocated to the target workstation;
wherein each workstation is preseted with a plurality of order-receiving strategies, and the current order-receiving strategy is one of the plurality of order-receiving strategies;
when a workstation is not allocated with an order that meets the current order-receiving strategy of the workstation within a preset duration, the computer program is configured to perform operation of switching the current order-receiving strategy of the workstation to an order-receiving strategy having a priority lower than that of the current order receiving strategy;
when a workstation is allocated with a plurality of orders that meet the current order-receiving strategy of the workstation within the preset duration and a quantity of the plurality of orders is greater than or equal to a first preset quantity value, the computer program is configured to perform operation of switching the current order-receiving strategy of the workstation to an order-receiving strategy having a priority higher than that of the current order-receiving strategy.
